(19) United States
(12) Patent Application Publication
(10) Pub. No.: US 2015/0140424 A1
(43) Pub. Date: May 21, 2015

(54) ACTIVE ELECTRODE MATERIAL COMPOSITION, ELECTRODE AND LITHIUM-ION SECONDARY BATTERY

(71) Applicant: Shanghai Sinopoly Jiahua Battery Technology Co., Ltd., Shanghai (CN)

(72) Inventors: Zifeng Ma, Shanghai (CN); Zhengwei Zhao, Shanghai (CN); Zhenguo Miao, Shanghai (CN)

(21) Appl. No.: 14/398,065

(22) PCT Filed: Oct. 8, 2012
(86) PCT No.: PCT/CN2012/082581

§ 371 Date: Oct. 30, 2014

(30) Foreign Application Priority Data
May 3, 2012 (CN) 201210134742.4

(51) Int. Cl. H01M 4/62; H01M 4/587; H01M 4/38; H01M 4/58

(52) U.S. Cl. CPC H01M 4/622; H01M 4/5825; H01M 4/587; H01M 4/386
USPC 429/217; 252/182.1

(57) ABSTRACT

Provided are an active electrode material composition for a lithium-ion secondary battery, an electrode for a lithium-ion secondary battery, and a lithium-ion secondary battery using the active electrode material composition. The active electrode material composition includes an active electrode material and a binder. The binder is characterized by existing in the form of a polyamide-amic acid compound in an electrode paste, and forming a polyamide-imide compound with excellent stability by means of high-temperature curing. The electrode paste is a water-based paste, which can avoid the use of an organic solvent in the electrode paste making process, and the obtained electrode has excellent structural stability and the battery performance is improved.

### FIELD OF INVENTION

The present invention relates to an active electrode material composition for lithium-ion secondary battery, a water-based paste and electrodes used for lithium-ion secondary battery, and lithium-ion secondary battery comprising the electrodes.

### PRIOR ARTS

In order to meet the development demand of miniaturization and lightweight of portable electronic devices, lithium-ionlithium-ion secondary battery dut to its high discharge voltage, high energy density and long cycle life has gradually replaced traditional secondary battery such as lead acid battery, Ni—Cd battery, nickel metal hydride battery, etc., and are playing an important role in small-sized secondary battery used for electronic devices. Moreover, lithium-ion secondary battery has been expected to be applied in electric vehicles, energy storage power stations and so on.

In prior art, an electrode of lithium-ion secondary battery is usually obtained by the following method: dispersing and mixing an active electrode material, a binder and auxiliary materials when necessary, such as a conductive agent, a thicker, a disperser, etc. in an organic solvent or water to form an electrode paste, then coating the paste onto a current collector, drying and pressing to obtain an electrode.

In preparation technology of a positive electrode of lithium-ion secondary battery, a dry electrode is obtained by evaporating the solvent after paste being slurried and the paste is typically prepared under a moistureless condition, using water unsoluable polyvinylidene fluoride (PVDF) as a binder, N-methyl-2-pyrrolidone (NMP) as an organic solvent to dissolve PVDF and NMP as a paste dispersion medium. In this process, the volatilization of the organic solvent not only pollutes the environment but also does harm to the health of operation staffs and the solvent evaporated in the drying process must be recycled, which results in high cost of the organic solvent, energy consumption when evaporating and recycling the organic solvent as well as environmental pollution. Additionally, the PVDF binder is unstable at high temperature and easy to decompose and react with the active positive material exothermicly, which affects the life and safety of battery.

To solve the problems mentioned above, water-based binders used for lithium-ion secondary battery are researched and developed, for example, a water-dispersible latex of acrylonitrile multipolymer (CN101457131) has been developed by Chengdu Indigo Power Sources Co. Ltd. and related products have been commercially available. However, electrodes using this binder are excessively hard and brittle whose flexbility is so insufficient that is hard for processing and winding. In addition, a styrene butadiene rubber (SBR) latex binder has been recognized by the market and widely used in carbon negative electrodes instead of positive electrodes due to its inefficiency in resistance to electrochemical oxidation.

On the other hand, to develop novel active electrode material with higher energy density and high specific capacity for lithium-ion secondary battery has become a research hotspot in the art. To substitute graphite negative electrode material with a theoretical specific capacity limitation of 372 mAh/g, researches on adopting elements like Si, Sn, etc. which are capable of reacting an alloying reaction with lithium and therefore have high specific capacity, as candidates for active negative material of next generation, are extremely hot. However, when the negative electrodes using material which is capable of reacting an alloying reaction with lithium as the main active material, changes of the volume of the active material are relatively great in the process of lithium adsorption and desorption. So the active material will have problems like micronization, separation from the current collector and reduction of current collecting efficiency inside the electrode, which leads to a worse charging/discharging cycle performance of the active material.

Japanese patent JP2002-260637 disclosed a technical solution for realizing a high current collecting efficiency within a negative electrode. The negative electrode prepared by curing an active material layer which contains active silicon-containing material and a polyimide binder at high temperature under non-oxidizing atmosphere exhibits a good charging/discharging cycle performance. United States patent US20060099506A1 disclosed an aliphatic polyimide binder used as a silicon alloy negative electrode, which decreased the content of carbonyl contained in the polymer and irreversible capacity consumption of battery caused by polymer participating electrochemical reaction compared to an aromatic polyimide binder. And Chinese patents CN101098026A, CN101192665A, CN1901260A, etc. disclosed that the electrochemical performance could be improved and the expansion of Si, Sn type electrodes could be inhibited by modifying the molecular structure of polyimide or co-using the polyimide with other binders.

Polyimide has good adhesion property, excellent mechanical strength and chemical stability. The problem for using polyimide as an electrode binder lies in the technical process instead of polyimide itself. Most of polyimide is insoluble. The polyimide solid is usually prepared by dehydrating and cyclizing polyamide acid (PAA) at high temperature and the polyamide acidis a precursor of polyimide which is prepared and used in an organic solvent, such as N-methylpyrrolidone, dimethylacetamide, dimethylformamide or dimethyl sulfoxide. The PAA solution has poor stability and is easy to precipitate and hard for storage. So there exists some problems such as inconvenience for use, high cost of organic solvents, energy consumption for evaporating and recycling organic solvents and environmental pollution when using the polyimide binder.

### CONTENTS OF THE PRESENT INVENTION

### Technical Problems to be Solved in the Present Invention

The main object of the present invention is to solve the problems of high costs of organic solvents, energy consumption for evaporating and recycling organic solvents and environmental pollution in preparing positive electrode when using a PVDF binder and an NMP solvent as well as to overcome the defects that the PVDF binder is unstable and easy to decompose at high temperature and reacts with the positive active material exothermicly so as to improve the battery life and safety in use.

Another object of the present invention is to meet the development demand of high energy density for lithium-ion secondary battery and the development trend of adopting novel alloy negative electrode with a high specific capacity such as Si, Sn and the like and provide a method overcoming the defects of micronization and separation from the current collector of an alloy negative electrode, reduction of current collecting efficiency, etc. so as to improve charging/discharging cycle performance of electrode; meanwhile to solve the problems of inconvenience when using polyimide as an alloy negative electrode binder, high costs of organic solvents, energy consumption for evaporating and recycling organic solvents and environmental pollution.

### Technical Solutions for Solving the Problems

The present invention provides an active electrode material composition for lithium-ion secondary battery, which comprises an active electrode material and a polyamide-imide compound as a binder ingredient. Wherein, the active electrode material is an active positive electrode material or an active negative electrode material.

In the present invention, the polyamide-imide compound used as an electrode binder exists in the form of a precursor polyamide-amic acid compound in electrode paste. The electrode paste contains the above-mentioned active electrode material, polyamide-amic acid compound and water as a dispersion medium. Wherein, the polyamide-amic acid compound contains a repeating structural unit represented by formula 1:

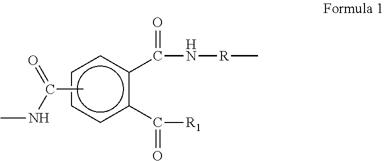

Two amide groups substituting in the aromatic ring in Formula 1 are the feature structures of 1, 3 polyamide-amic acid compound and 1, 4 polyamide-amic acid compound. Wherein, R₁ is a segment deriving from neutralization reaction of organic or inorganic alkali compounds and carboxyl group.

In the present invention, the active positive electrode material is powder material that can take lithiation and delithiation reaction and is selected from the group consisting of lithium oxides containing cobalt, nickel, manganese and vanadium, lithium phosphates containing iron, cobalt, nickel, manganese and vanadium, lithium silicates containing iron, cobalt, nickel, manganese and vanadium and lithium titanate, and the combinations thereof.

In the present invention, the active negative electrode material is selected from the group consisting of the material with capability of reversible intercalation/deintercalation of lithium-ion, and the material capable of reacting with lithium to form lithium compounds. Wherein, the material with capability of reversible intercalation/deintercalation of lithium-ion is carbon material, and the material capable of reacting with lithium to form lithium compounds is selected from the group consisting of tin, tin alloy, tin oxide, silicon, silicon alloy, silicon oxide, silicon carbon composite, and the combinations thereof.

In the active electrode material composition of the present invention, the polyamide-imide compound used as the electrode binder contains a repeating amide-imide structural unit represented by formula 2 and a repeating amide-amido acid structural unit represented by formula 3:

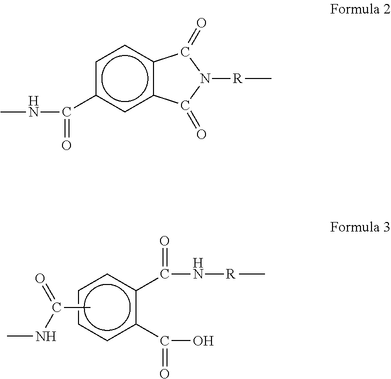

Two amide groups substituting in the aromatic ring in Formula 3 are two feature structures of 1, 3 polyamide-amido acid and 1, 4 polyamide-amido acid.

Wherein, R is a bivalent arylene, the molar ratio of the amide-imide structural units to the total moles of the amide-imide structural units and the amide-amido acid structural units is no less than 80%.

In the present invention, the polyamide-imide compound used as the electrode binder has a weight-average molecular weight ranging from about 1000 to 100000. In the active electrode material composition, the content of the polyamide-imide compound is 0.2-20 wt % and the content of the active electrode material is 80-99.8 wt % on the basis of the total weight of the active electrode material and the polyamide-imide compound.

The present invention provides an electrode comprising a current collector and an active electrode material composition loaded on the current collector. The features of the active electrode material composition are as stated above.

The present invention also provides a lithium-ion secondary battery comprising a positive electrode, a negative electrode and a non-aqueous electrolyte. The positive electrode and/or negative electrode is the electrode stated above.

### Effects of the Present Invention

In the present invention, the electrode binder contains polyamide-imide compound. Since there are a large number of imide groups in the molecular structure of polyamide-imide, the electrode binder displays high cohesiveness. Since the imide group has high polarity, the electrode binder exhibits high cohesiveness with metal foil such as aluminum foil and copper foil which is particle of the active electrode material and used as current collector of the electrode. Besides, there also exists a large number of amide groups (—NH—CO—) in the molecular structure of polyamide-imide, which reduces the rigidity of the molecular chain. Polyamide-imide as an electrode binder shows excellent cohesiveness, mechanical strength and stability, and the flexibility of the electrode using a polyamide-imide binder also be improved compared to the electrode using a polyimide binder. So the polyamide-imide binder is particularly suitable for novel negative electrodes like Si alloy, Sn alloy, etc., with high expansion property. The electrode using a polyamide-imide binder can inhibit the failure of the conductive channel between active material particles and avoid the separation of the active material particles from the current collector during the process of charging/discharging of the electrode, and can also improve current collecting efficiency within the electrode, charging/discharging cycle performance of the electrode, as well as processing performance of the electrode compared to the electrode using a polyimide binder.

In the present invention, the polyamide-imide electrode binder exists in the form of its precursor polyamide-amic acid compound in the water-based electrode paste, and the polyamide-amic acid compound completely dissolves or mostly dissolves in water. The realization of preparing the paste with water-based ingredients during the process of electrode preparation avoids using organic solvents, such as NMP etc., with high boiling point and toxicity, saves the cost of organic solvents and avoids environmental pollution. In addition, because of high cohesiveness and excellent chemical, electrochemical stability of polyamide-imide, it can replace the existing positive electrode preparation process which uses PVDF as a binder and NMP as a solvent and overcome the defects that PVDF binder is unstable and easy to decompose at high temperature and react with the active positive material exothermicly so as to enhance the chemical stability of the binder and improve life and safety of battery. Furthermore, the water-soluble binder precursor polyamide-amic acid compound can co-use with other water-soluble binder products such as carboxymethyl cellulose (CMC), polyvinylpyrrolidone (PVP), and water-dispersible latex binder products such as styrene butadiene rubber (SBR), polytetrafluoroethylene (PTFE), acrylonitrile copolymer as a electrode binder to meet the manufacturing requirement of paste coating and the demand of product performance.

### DETAILED DESCRIPTION OF THE PREFERRED EMBODIMENT

Hereinafter, the present invention will be described in detail.

In the present invention, the polyamide-imide compound used as the electrode binder exists in the form of its precursor polyamide-amic acid compound in the electrode paste. The polyamide-amic acid compound contains a repeating structural unit represented by formula 1:

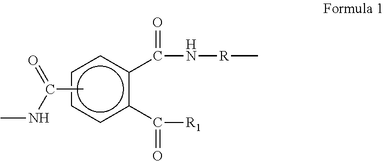

R is a bivalent arylene deriving from aromatic diamine, preferably selected from the group consisting of

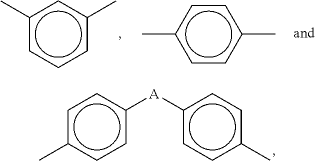

wherein A is a bivalent group, for example selected from the group consisting of —SO₂+, —CO—, —C(CH₃)₂—, —O—, —S— and a chemical bond, but not limited thereto.

R₁ is a segment deriving from neutralization reaction of an organic or inorganic alkali compound and a carboxyl group. The organic or inorganic alkali compound are preferably amine compounds, for example but not limited to tertiary amine, more preferably volatile tertiary amine with low boiling point, for example but not limited to triethylamine, which can make —CO—R₁ easy to decompose and volatilize during heating process and make polyamide-amido acid cyclize and cure.

The polyamide-amic acid compound is comprised of the repeating unit represented by formula 1 and the repeating unit represented by formula 3, and the repeating unit represented by formula 2 is inevitably generated in the synthetic process of polyamide-amido acid. To make the polyamide-amic acid compound completely soluble or at least mostly soluble in the electrode paste, the content of the repeating unit represented by formula 1 is no less than 60%, preferably no less than 80%, more preferably no less than 90% on the basis of the total moles of the repeating units represented by formula 1, formula 2 and formula 3.

In the process of preparing the paste with ingredients, the polyamide-amic acid compound can be added in the form of aqueous solution, or in the form of solid and then the solid is dissolved and dispersed through the acid-alkali neutralization in the paste. For example, the aqueous solution of the polyamide-amic acid compound can be selected from the group consisting of Torlon AI-30 and Torlon AI-50 of Solvay Advanced Polymers, L.L.C., but not limited thereto.

Active Positive Electrode Material Composition and Positive Electrode

The positive electrode of the present invention comprises a positive electrode current collector and an active positive electrode material composition loaded on the current collector.

The active positive electrode material composition contains an active positive electrode material and a binder ingredient polyamide-imide compound. The content of the polyamide-imide compound is 0.2-20 wt %, preferably 1-12 wt %, more preferably 3-8 wt % on the basis of the total weight of the active positive electrode material and the polyamide-imide compound.

The active positive electrode material is a powder material that can take lithiation and delithiation reaction. The active positive electrode material is selected from the group consisting of lithium oxides containing cobalt, nickel, manganese and vanadium, lithium phosphates containing iron, cobalt, nickel, manganese and vanadium, lithium silicates containing iron, cobalt, nickel, manganese and vanadium and lithium titanate, and the combinations thereof. For example, the active positive electrode material can be selected from the group consisting of LiCoO₂, LiNiO₂, LiMnO₂, LiMn₂O₄, NCA, NMC, Li₃V₂(PO₄)₃, LiVPO₄F, LiMnPO₄ and LiFePO₄/C, but not limited thereto.

The active positive electrode material can further contains a conductive agent to improve the electron conduction between particles of active material and also between particles of active material and the current collector. The conductive agent can be any conductive agent known in the field, for example, natural graphite, artificial graphite, acetylene black, ketjen black, carbon fibers, carbon nanotubes, conductive carbon black, conducting polymers and metal powder or metallic fibers containing copper, nickel, aluminum, silver, etc. The weight ratio of the conductive agent to the active positive electrode material can be (1˜15):100, preferably (2˜10):100, more preferably (3˜8):100.

Besides the above-mentioned polyamide-imide compound, the active positive electrode material can also contains other binder ingredient, the weight ratio of other binder ingredient to the active positive electrode material composition is preferably no more than 8%, more preferably no more than 5%. For example, other binder ingredient includes polyvinyl alcohol, carboxymethyl cellulose, hydroxyl acrylic cellulose, polyvinylpyrrolidone, polytetrafluoroethylene, polyethylene, polypropylene and acrylonitrile polymers, but not limited thereto. Polymer containing unsaturated alkene double bond, such as styrene butadiene rubber, is likely to participate in electrochemical reaction and degrade under a positive potential, thus it is not an ideal choice as a positive electrode binder.

In the present invention, the current collector of positive electrode is not defined specially, which can be commonly used current collector of positive electrode for lithium-ion battery, such as aluminum foil, nickel net, nickel foam.

The positive electrode is prepared according to the following method: preparing a paste with an active positive electrode material, a binder, a conductive agent and deionized water. The amount of the deionized water can be adjusted flexibly according to the viscosity request of the paste and the operational requirement, which is common knowledge for the people skilled in the art. In the process of preparing the paste, proper amount of a water-soluable organic solvent or alcohol can be added to promote the dissolution and dispersion of the binder. Then the positive electrode paste is coat onto the positive electrode current collector and drying, then it is heated to make the polyamide-amic acid compound curing. The curing temperature is 150˜450° C., preferably 200˜350° C., more preferably 250˜300° C. The heating time for curing is preferably 0.5˜12 hours and can be adjusted according to the curing temperature to make the molar ratio of the amide-imide structural units to the total moles of the amide-imide structural units and the amide-amido acid structural units in the polyamide-imide binder no less than 80%, preferably no less than 90%, more preferably no less than 95%.

Active Negative Electrode Material Composition and Negative Electrode

The negative electrode of the present invention includes a negative electrode current collector and an active negative electrode material composition loaded on the current collector.

The active negative electrode material composition contains an active negative electrode material and a binder ingredient a polyamide-imide compound. The content of the polyamide-imide compound is 0.2-20 wt %, preferably 1-12 wt %, more preferably 3-8 wt % on the basis of the total weight of the active negative electrode material and the polyamide-imide compound.

The active negative electrode material is selected from the group consisting of the material with capability of reversible intercalation/deintercalation of lithium-ion, and the material capable of reacting with lithium to form lithium compounds. Wherein, the material with capability of reversible intercalation/deintercalation of the lithium-ion is a carbon material, for example, natural graphite, artificial graphite, mesocarbon microbeads, hard carbon. The material capable of reacting with lithium to form lithium compounds is selected from the group consisting of tin, tin alloy, tin oxide, silicon, silicon alloy, silicon oxide, silicon carbon composite, and the combinations thereof.

The active negative electrode material composition can further contains a conductive agent. The conductive agent can be any conductive agent known in the field, for example, natural graphite, artificial graphite, acetylene black, ketjen black, carbon fibers, carbon nanotubes, conductive carbon black, conducting polymers and metal powder or metallic fibers containing copper, nickel, aluminum, silver, etc. The amount of the conductive agent can be adjusted according to the conductive performance of the active negative electrode material. The weight ratio of the conductive agent to the active negative electrode material is no more than 15%, preferably no more than 10%, more preferably no more than 8%.

Besides the above-mentioned polyamide-imide compound, the active negative electrode material composition can also contains other binder ingredient, the weight ratio of other binder ingredient to the active negative electrode material composition is preferably no more than 8%, more preferably no more than 5%. Other binder ingredient can be, for example, polyvinyl alcohol, carboxymethyl cellulose, hydroxyl acrylic cellulose, polyvinylpyrrolidone, polytetrafluoroethylene, polyethylene, polypropylene, acrylonitrile polymers, styrene butadiene rubber, and butadiene-acrylonitrile rubber, but not limited thereto.

In the present invention, the current collector of negative electrode is not defined specially, which can be commonly used current collector of negative electrode for lithium-ion battery, such as copper foil, nickel copper alloy foil, stainless steel foil, nickel net, nickel foam. For the negative electrode of silicon or stannum, nickel copper alloy foil is preferred.

The preparation method of the negative electrode is similar to that of the positive electrode, herein no detailed illustration.

Lithium-Ion Secondary Battery

The present invention provides a lithium-ion secondary battery, comprising a positive electrode, a negative electrode and a non-aqueous electrolyte. The positive electrode and/or negative electrode are electrodes provided by the present invention. In further description, for example, when the positive electrode provided by the present invention is used, the counter electrode can be the negative electrode provided by the present invention or the negative electrode commonly used in the field. When the negative electrode provided by the present invention is used, the counter electrode can be the positive electrode provided by the present invention or the positive electrode commonly used in the field.

In the lithium-ion secondary battery of the present invention, the non-aqueous electrolyte is not defined specially, which can be a non-aqueous liquid electrolyte or a solid electrolyte.

The non-aqueous liquid electrolyte includes a non-aqueous organic solvent and a lithium salt. The non-aqueous organic solvent serves as a medium for transporting ions involved in electrochemical reaction of the battery. The non-aqueous organic solvent includes carbonic esters, carboxylic esters, ethers, ketones, alcohols or aprotic solvents. Appropriate solvent of carbonic esters includes, for example, dimethyl carbonate, diethyl carbonate, dipropyl carbonate, methyl propyl carbonate, methyl ethyl carbonate, ethylene carbonate, propylene carbonate, fluoro carbonate and so on, but not limited thereto. Appropriate solvent of carboxylic esters includes, for example, methyl acetate, ethyl acetate, n-propyl acetate, methyl propionate, ethyl propionate, butyrolactone and so on, but not limited thereto. Appropriate solvent of ethers includes, for example, dibutyl ether, tetraethylene glycol dimethyl ether, diethylene glycol dimethyl ether, dimethoxyethane, 2-methyltetrahydrofuran, tetrahydrofuran and so on, but not limited thereto. Appropriate solvent of ketones includes, for example, cyclohexanone and so on, but not limited thereto. Appropriate solvent of alcohols includes, for example, ethanol, isopropyl alcohol and so on, but not limited thereto. Appropriate aprotic solvents include, for example, nitrile (for example X—CN, wherein X is a straight-chain, branched or cyclic alkyl or aryl having 2˜20 carbon atoms), amide (for example dimethylformamide), dioxolane (for example 1, 3-dioxolane) and sulfolane, but not limited thereto.

The non-aqueous organic solvent can include a single solvent or a mixture of solvents. When a mixture of solvents is used, the proportion of the mixture can be adjusted according to the expected performance of battery. The solvent of carbonic esters can include a mixture of cyclic carbonate and chain-like carbonate. When the cyclic carbonate and chain-like carbonate are mixed with a volume proportion ranging from 1:1 to 1:9 and used as electrolyte, the performance of the electrolyte can be improved.

The non-aqueous liquid electrolyte can also include additives, for example, carbon dioxide, vinylene carbonate, fluorinated ethylene carbonate, sultones, biphenyl, cyclohexyl benzene, to improve the performance or safety of battery. The additives are added in an appropriate dosage.

Dissolving the lithium salt in the non-aqueous organic solvent is beneficial for lithium ion transportation between the positive electrode and the negative electrode. The appropriate lithium salt includes, for example, LiPF₆, LiBF₄, LiCF₃SO₃, LiN(SO₂C₂F₅)₂, LiN(CF₃SO₂)₂, LiN(CF₃SO₂)(C₄F₉SO₂), LiC(CF₃SO₂)₃, LiC(C₂F₅SO₂)₃, LiClO₄, LiCl, LiI, LiBOB, LiDFOB, LiTFOP, and the combinations thereof, but not limited thereto. The lithium salt is used in a concentration ranging from about 0.1M to 2M.

Appropriate solid electrolyte can be selected from the group consisting of gel polymer electrolytes formed by dipping electrolyte solution into polymer electrolytes such as polyethylene oxide, polyacrylonitrile, etc., and inorganic solid electrolytes such as LiI, Li₃N, etc.

The lithium-ion secondary battery usually includes a diaphragm between a positive electrode and a negative electrode. Appropriate diaphragm includes, for example, polyethylene, polypropylene, polyvinylidene fluoride, polyimide and a multilayer composite membrane formed by the combinations thereof, but not limited thereto.

The preparation method of the lithium-ion secondary battery provided by the present invention is according to the common method known to the people skilled in the art. Generally, the method includes sequentially stacking or winding the positive electrode, the negative electrode and the diaphragm between the positive electrode and the negative electrode into an electric core, placing the electric core into a battery shell, then injecting the electrolyte and sealing. The shape of the lithium-ion secondary battery in the present invention is not defined specially, which can be, but not limited to, a steel cylindrical shell, a steel or aluminum square shell, an aluminum-plastic soft film package and so on.

### Embodiments

Hereinafter, specific embodiments are listed to further illustrate the present invention, but the present invention is not limited thereto and the present invention can be implemented with appropriate alteration within the scope of the present invention.

Performance of active electrode material compositions, electrodes and battery prepared by the embodiments and comparative examples is evaluated by the following methods.

Evaluation Methods

[Electrode Flexibility]

The electrode used for lithium-ion secondary battery was cut into rectangles with a size of 100×50 mm as test pieces, then a divider with 3 mm, 5 mm and 8 mm was used as a round mandrel respectively and the test piece was bended round the round mandrel from a horizontal state to 180 degree to observe the fracture condition of the electrode test piece. When the diameter of the round mandrel was changed, the flexibility was evaluated by the diameter at which fracture occurred. The smaller the diameter of the round mandrel at which the electrode does not fracture is, the better the flexibility of the electrode has.

No fracture occurred when the diameter of round mandrel is 3 mm, marking with A.

No fracture occurred when the diameter of round mandrel is 5 mm, marking with B.

No fracture occurred when the diameter of round mandrel is 8 mm, marking with C.

Fracture occurred when the diameter of round mandrel is 8 mm, marking with D.

[Peeling Strength]

The electrode was cut into rectangles with a size of 100×25 mm as test pieces, then the active electrode material layer was fixed. Then transparent tape was pasted on the surface of the active material layer of the test piece, and peeling stress at 180 degree with a speed of 50 mm/min from one end of the test piece was measured. The peeling strength was an average value of 5 repetitive measurements. The higher the peeling strength is, the better cohesiveness between the active electrode material layer and the current collector is.

[Battery Performance]

The lithium-ion secondary battery was charged to 3.8V with a constant current of 0.5 C at 25° C., afterwards charged with a constant voltage of 3.8V till the current reaching 0.05 C, then kept standing for 10 min, and then discharged to 2.0V with a constant current of 0.2 C. The obtained discharge capacity was the initial capacity of the battery at normal temperature.

Then the battery was charged according to the above-mentioned charging mode and discharged to 2.0V with a constant current of 2 C. The percentage of 2 C discharge capacity to 0.2 C discharge capacity was set as rate discharge characteristic.

Repeat the above-mentioned charge process and discharge process at a constant current of 0.5 C for 100 cycles. The percentage of discharge capacity of the 100th cycle to the first cycle was set as cycle characteristic at normal temperature.

Repeat the above-mentioned charge process and discharge process at a constant current of 0.5 C at 55° C. for 100 cycles. The percentage of discharge capacity of the 100th cycle to the first cycle was set as cycle characteristic at elevated temperature.

### Electrode Preparation

### Embodiment 1

An electrode binder precursor: An aqueous solution of polyamide-amic acid compound Torlon AI-30 with a solid content of 35 wt %.

A positive electrode A1 was prepared by mixing LiFePO₄/C powder, acetylene black and the above electrode binder precursor in a mass ratio of 100:6:17.1 with deionized water to form a paste, coating the paste onto both sides of an aluminum foil current collector in with a thickness of 20 μm and drying at 80° C., afterwards heating to cure at 250° C. for 3 hours, then rolling and cutting into sheets with a size of 485 mm×44 mm.

### Comparative Example 1

A positive electrode AC1 was prepared by mixing LiFePO₄/C powder, acetylene black and polyvinylidene fluoride (PVDF) in a mass ratio of 100:6:6 with NMP to form a paste, coating the paste onto both sides of an aluminum foil current collector with a thickness of 20 μm and drying at 120° C., afterwards rolling and cutting into sheets with a size of 485 mm×44 mm.

### Comparative Example 2

An electrode binder: A water-soluble binder of acrylonitrile copolymer LA133 with a solid content of 15 wt %.

A positive electrode AC2 was prepared by mixing LiFePO₄/C powder, acetylene black and the above solution of binder in a mass ratio of 100:6:40 with deionized water to form a paste, coating the paste onto both sides of an aluminum foil current collector with a thickness of 20 μm and drying at 120° C., afterwards rolling and cutting into sheets with a size of 485 mm×44 mm.

### Embodiment 2

An electrode binder precursor: An aqueous solution of polyamide-amic acid compound Torlon AI-30 with a solid content of 35 wt %.

A negative electrode B1 was prepared by mixing artificial graphite, acetylene black and the above binder precursor in a mass ratio of 100:3:12.8 with deionized water to form a paste, coating the paste onto both sides of a copper foil current collector with a thickness of 12 μm and drying at 80° C., afterwards heating to cure at 250° C. for 3 hours, then rolling and cutting into sheets with a size of 480 mm×45 mm.

### Embodiment 3

An electrode binder precursor: An aqueous solution of polyamide-amic acid compound Torlon AI-30 with a solid content of 35 wt %.

A negative electrode B2 was prepared by mixing artificial graphite, acetylene black, CMC and the above binder precursor in a mass ratio of 100:3:2:7.1 with deionized water to form a paste, coating the paste onto both sides of a copper foil current collector with a thickness of 12 μm and drying at 80° C., afterwards heating to cure at 250° C. for 3 hours, then rolling and cutting into sheets with a size of 480 mm×45 mm.

### Comparative Example 3

A negative electrode BC1 was prepared by mixing artificial graphite, acetylene black, CMC and SBR in a mass ratio of 100:3:2:2.5 with deionized water to form a paste, coating the paste onto both sides of a copper foil current collector with a thickness of 12 μm and drying at 120° C., afterwards rolling and cutting into sheets with a size of 480 mm×45 mm.

### Embodiment 4

An electrode binder precursor: An aqueous solution of polyamide-amic acid compound Torlon AI-30 with a solid content of 35 wt %.

A negative electrode B3 was prepared by mixing micro silicon powder (2 μm˜5 μm), carbon fibers and the above binder precursor in a mass ratio of 100:8:22.8 with deionized water to form a paste, coating the paste onto both sides of a copper foil current collector with a thickness of 18 μm and drying at 80° C., afterwards heating to cure at 250° C. for 3 hours, then rolling and cutting into sheets with a size of 480 mm×45 mm.

### Comparative Example 4

An electrode binder precursor: A polyamide acid solution, which is a precursor of polyimide, with a solid content of about 25 wt %.

A negative electrode BC2 was prepared by mixing micro silicon powder (2 μm˜5 μm), carbon fibers and the above solution of binder in a mass ratio of 100:8:32 with NMP to form a paste, coating the paste onto both sides of a copper foil current collector with a thickness of 18 μm and drying at 120° C., afterwards heating to cure at 250° C. for 3 hours, then rolling and cutting into sheets with a size of 480 mm×45 mm.

Test results of flexibility and peeling strength of the above electrodes were shown in table 1.

TABLE 1

| | | | | | | Peeling |
|---|---|---|---|---|---|---|
| | Elec- | Active | | Paste | Electrode | strength |
| | trode | material | Binder | system | flexibility | (N/m) |
| Embodiment | A1 | LiFePO₄/ | PAI | Water | A | 23 |
| 1 | | C | | | | |
| Comparative | AC1 | LiFePO₄/ | PVDF | NMP | B | 8 |
| example 1 | | C | | | | |
| Comparative | AC2 | LiFePO₄/ | PAN | Water | C | 13 |
| example 2 | | C | | | | |
| Embodiment | B1 | Artificial | PAI | Water | A | 18 |
| 2 | | graphite | | | | |
| Embodiment | B2 | Artificial | PAI + | Water | B | 15 |
| 3 | | graphite | CMC | | | |
| Comparative | BC1 | Artificial | SBR + | Water | A | 9 |
| example 3 | | graphite | CMC | | | |
| Embodiment | B3 | Micro | PAI | Water | A | 26 |
| 4 | | silicon | | | | |
| | | powder | | | | |
| Comparative | BC2 | Micro | PI | NMP | B | 29 |
| example 4 | | silicon | | | | |
| | | powder | | | | |

Battery Preparation

A diaphragm: APE film with a thickness of 20 μm.

A non-aqueous electrolyte: Lithium salt, LiPF₆, as an electrolyte with a concentration of 1 mol/L and a mixture of EC, DEC and FEC with a weight ratio of 3:6:1 as a solvent system.

A 053450 type lithium-ion secondary battery was prepared by using the above positive electrode, negative electrode, diaphragm and electrolyte according to the common method. Selection of the positive electrode and negative electrode and the evaluation results of performance were shown in table 2.

TABLE 2

| | | | Initial | | Cycle | Cycle |
|---|---|---|---|---|---|---|
| | | | capacity | | characteristic | characteristic |
| | | | at | Rate | at | at |
| | Positive | Negative | normal | discharge | normal | elevated |
| Battery | electrode | electrode | temperature | characteristic | temperature | temperature |
| Battery 1 of | A1 | B1 | 910 mAh | 95.8% | 93.8% | 89.5% |
| the present | | | | | | |
| invention | | | | | | |
| Battery 2 of | A1 | B2 | 900 mAh | 93.6% | 92.9% | 86.5% |
| the present | | | | | | |
| invention | | | | | | |
| Battery 3 of | A1 | BC1 | 920 mAh | 94.0% | 91.7% | 86.8% |
| the present | | | | | | |
| invention | | | | | | |
| Battery 4 of | A1 | B3 | 1130 mAh | 86.7% | 83.3% | 77.6% |
| the present | | | | | | |
| invention | | | | | | |
| Battery 5 of | AC1 | B1 | 910 mAh | 96.1% | 92.8% | 83.7% |
| the present | | | | | | |
| invention | | | | | | |
| Battery 6 of | AC1 | B2 | 920 mAh | 92.7% | 93.1% | 81.9% |
| the present | | | | | | |
| invention | | | | | | |
| Comparative | AC1 | BC1 | 930 mAh | 95.6% | 91.8% | 81.6% |
| battery 1 | | | | | | |
| Comparative | AC1 | BC2 | 1150 mAh | 83.2% | 78.5% | 71.3% |
| battery 2 | | | | | | |
| Comparative | AC2 | BC1 | 870 mAh | 88.6% | 89.7% | 82.6% |
| battery 3 | | | | | | |
| Comparative | AC2 | BC2 | 1020 mAh | 77.5% | 80.6% | 73.5% |
| battery 4 | | | | | | |

1. An active electrode material composition for lithium-ion secondary battery, comprising an active electrode material and a polyamide-imide compound, wherein,
the polyamide-imide compound is obtained by curing a polyamide-amic acid compound at high temperature, the polyamide-amic acid compound contains a repeating structural unit represented by formula 1 and can be partially or completely dissolved in water, 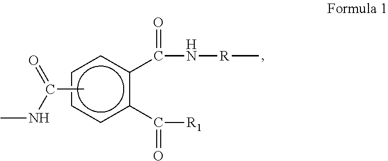
two amide groups substituting in the aromatic ring in Formula 1 are the feature structures of 1, 3 polyamide-amic acid compound and 1, 4 polyamide-amic acid compound, wherein R₁ is a segment deriving from neutralization reaction of organic or inorganic alkali compounds and carboxyl group.

2. The active electrode material composition according to claim 1, wherein the active electrode material is a positive electrode material or an active negative electrode material.

3. The active electrode material composition according to claim 2, wherein the active positive electrode material is a powder material that can take lithiation and delithiation reaction, which is selected from the group consisting of lithium oxides containing cobalt, nickel, manganese and vanadium, lithium phosphates containing iron, cobalt, nickel, manganese and vanadium, lithium silicates containing iron, cobalt, nickel, manganese and vanadium and lithium titanate, and the combinations thereof.

4. The active electrode material composition according to claim 2, wherein the active negative electrode material is selected from the material with capability of reversible intercalation/deintercalation of lithium-ion, or the material capable of reacting with lithium to form lithium compounds.

5. The active electrode material composition according to claim 4, wherein the material with capability of reversible intercalation/deintercalation of lithium-ion is a carbon material.

6. The active electrode material composition according to claim 4, wherein the material capable of reacting with lithium to form lithium compounds is selected from the group consisting of tin, tin alloy, tin oxide, silicon, silicon alloy, silicon oxide and silicon carbon composite, and the combinations thereof.

7. The active electrode material composition according to claim 1, wherein the polyamide-imide compound contains a repeating structural unit of amide-imide represented by formula 2 and a repeating structural unit of amide-amido acid represented by formula 3: 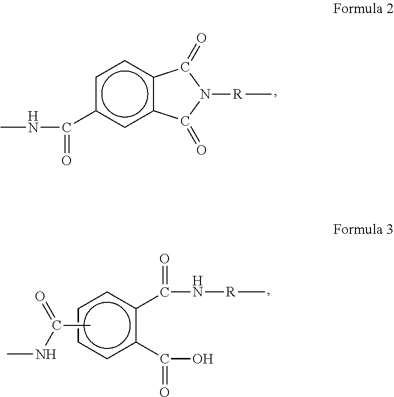
two amide groups substituting in the aromatic ring in Formula 3 are two feature structures of 1, 3 polyamide-amido acid and 1, 4 polyamide-amido acid,
wherein, R is a bivalent arylene, and the molar ratio of the amide-imide structural unit to the total moles of the amide-imide structural unit and the amide-amido acid structural unit is no less than 80%.

8. The active electrode material composition according to claim 1, wherein the polyamide-imide compound has a weight-average molecular weight ranging from about 1000 to 100000.

9. The active electrode material composition according to claim 1, wherein the content of the polyamide-imide compound is 0.2-20 wt % and the content of the active electrode material is 80-99.8 wt % on the basis of the total weight of the active electrode material and the polyamide-imide compound.

10. The active electrode material composition according to claim 1, wherein the polyamide-imide compound exists in the form of polyamide-amic acid compound in an electrode paste, the electrode paste contains the polyamide-amic acid compound, the active electrode material according to claim 2 and water as a dispersion medium.

11. An electrode, comprising a current collector and an active electrode material composition loaded on the current collector, wherein the active electrode material composition is the active electrode material composition according to claim 1.

12. A lithium-ion secondary battery, comprising a positive electrode, a negative electrode and a non-aqueous electrolyte, and the positive electrode and/or negative electrode is the electrode according to claim 11.
